(19) United States
(12) Patent Application Publication
(10) Pub. No.: US 2016/0328498 A1
(43) Pub. Date: Nov. 10, 2016

(54) Topology-Based Method to Assess the Environmental Impact of Deicing Sodium Chloride

(71) Applicant: International Business Machines Corporation, Armonk, NY (US)

(72) Inventors: Ying Liu, Austin, TX (US); Lucas C. Villa Real, Sao Paulo (BR)

(73) Assignee: International Business Machines Corporation, Armonk, NY (US)

(21) Appl. No.: 14/705,574

(22) Filed: May 6, 2015

(51) Int. Cl. G06F 17/50; G06F 17/10

(52) U.S. Cl. CPC G06F 17/5009; G06F 17/10

(57) ABSTRACT

An approach is provided for simulating environmental impacts of road salt impact by providing a first-order salt load model that may be run on an information handling system to estimate the spatial differentiation on the environmental impact of road salt in a specified watershed area using only topological information for the specified watershed area. The disclosed salt load model employs a reservoir model to determine the salt loading coefficient c=1/(1+e^{-λ}) for each target point in the landscape, where the topographical index term λ may be efficiently computed by adjusting a topological wetness index term generated by the TOPMODEL runoff generation model to compute the salt loading coefficient c as a two-dimensional map using only topological or elevation data for the watershed area of interest.

### BACKGROUND OF THE INVENTION

Road salt is often used as a de-icing agent in cold weather locations to prevent the formation of road ice. Typically including one or more chemical components, such as sodium chloride, ferrocynanide (an anti-caking agent), phosphorus, iron, and other impurities, road salt can provide a major non-point source of pollutants that can have severe impacts on surface and groundwater quality, soil, vegetation, wild life, aquatic life, and other environmental effects. To the extent that such environmental effects can be modeled to better understand and control the impact of de-icing salt in order to achieve and maintain good environmental status around roads, operational modeling tools have been proposed for monitoring the transport and location of de-icing salt in the roadside environment in order to quantify changes in the environment at various spatial and temporal scales. Typically, such modeling tools employ detailed 3D transport models in combination with various independent field measurements to provide a numerical simulation of the road salt impact on increased chloride concentration in soil and groundwater. However, such chloride concentration modeling are very expensive to set up and run, and require detailed input data, such as topology, soil conditions, underground rock formations, vegetation coverage and growth, etc. As a result, the existing solutions for simulating the impact of road salt are computationally inefficient and extremely difficult at a practical

### SUMMARY

Broadly speaking, selected embodiments of the present disclosure provide a system, method, and apparatus for simulating environmental impacts of road salt impact by providing a first-order model that may be run on an information handling system to estimate the spatial differentiation on the environmental impact of road salt in a specified watershed area using only topological information for the specified watershed area. Instead of using complex and time-consuming models with multiple data inputs to compute an exact chloride concentration, the disclosed first-order salt load model is executed by the information handling system to quickly and efficiently compute a relative salt load metric along specified portions of a road to identify which portions of the road will have a bigger contribution to the overall chloride runoff. In selected embodiments of the present disclosure, the salt load model employs a reservoir model to determine the salt loading coefficient c=1/(1+e^{-λ}) for each target point in the landscape, where the topographical index term λ=ln(α/(α₀ tan β)) is computed on the basis of a (the amount of water in the upslope contributing area per unit contour length for each point in the catchment area), tan β (the straight line drop-off angle between the target point on the landscape and the destination flow drainage point), and α₀ (a tuning parameter). To efficiently compute the topographical index term λ, selected embodiments of the disclosed salt load model may use the TOPMODEL runoff generation model to compute a topological wetness index (TWI)=ln(α/tan β₀), where β₀ is the slope at the target point. In such embodiments, the salt load model also computes a correction term, ln(tan β₀/a₀ tan β), which is added to the TWI to correct for the local slope β₀, thereby computing the topographical index term λ=ln(α/(α₀ tan β))=TWI+ln(tan β₀/a₀ tan β). With the computed correction term, the salt load model can numerically be treated as an extension of the TOPMODEL runoff generation model to compute the salt loading coefficient c as a two-dimensional map using only topological or elevation data for the watershed area of interest. In addition, the salt loading coefficients c(x) and amount of salt applied per unit area m(x) along a road L within a specified catchment area may be integrated to compute the total estimated salt concentration M at a selected drainage point for the local catchment area, as represented by the equation M=∫_{L}m(x)·c(x)dx.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of an information handling computer system with a processor and components for executing a salt loading model which uses topological elevation data to assess the environmental impact of road salt;

FIG. 2 illustrates a two-dimensional salt loading coefficient map generated from topological elevation data;

FIG. 3 illustrates the integration of salt loading coefficients along a road in a drainage basin; and

FIG. 4 illustrates a simplified flow chart showing the logic for efficiently computing a salt loading coefficient map for different road segments and estimating the combined salt concentration at a specified drainage point.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

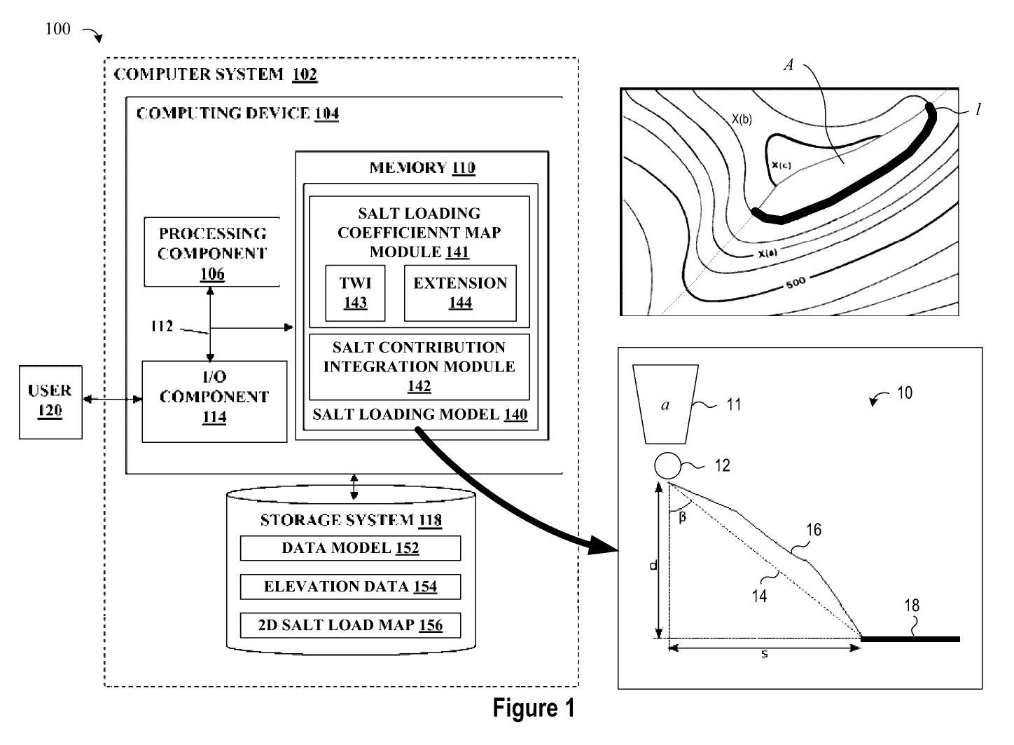

FIG. 1 depicts a schematic block diagram of one illustrative embodiment of an information handling computer system 100 for running a salt loading model 140 which uses topological elevation data 154 to numerically simulate the distribution of road salt in a specified watershed area. The depicted environment 100 includes a computer system 102 that can perform a process described herein for assessing the environmental impact of deicing sodium chloride. In particular, computer system 102 is shown including a computing device 104 that includes a salt loading model program 140 which makes computing device 104 operable to provide a first-order model which processes topological data to estimate the spatial differentiation on the environmental impact of road salt in a specified watershed area by performing a process described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as salt loading model program 140, which is at least partially fixed in memory 110. To this extent, processing component 106 may include a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may include any known type of temporary or permanent data storage media, including magnetic media, optical media, random access memory (RAM), read-only memory (ROM), a data cache, a data object, etc. In addition, memory 110 may reside at a single physical location, including one or more types of data storage, or be distributed across a plurality of physical systems in various forms.

While executing program code, processing component 106 can process data., which can result in reading and/or writing transformed data from/to memory 110 and/or I/O component 114 for further processing. Pathway 112 provides a direct or indirect communications link between each of the components in computer system 102. I/O component 114 can include one or more human I/O devices, which enable a human user 120 to interact with computer system 102 and/or one or more communications devices to enable a system user 120 to communicate with computer system 102 using any type of communications link. To this extent, salt loading model program 140 can manage a set of interfaces (e.g., graphical user interface(s), application program interface, and/or the like) that enable human and/or system users 120 to interact with the salt loading model program 140. Users 120 could include government decision-makers, environmentalists, and/or clients Who need an efficient mechanism to estimate the ecological impact of chloride in a specified environmental area. Further, salt loading model program 140 can manage (e.g., store, retrieve, create, manipulate, organize, present, etc.) the data in storage system 118, including, but not limited to a data model 152, elevation dataset description 154, and/or observed values, using any desired data management mechanism.

In selected embodiments, computer system 102 may be embodied with one or more computing devices 104 (e.g., general purpose computing articles of manufacture) capable of executing program code, such as salt loading model program 140, installed thereon. As used herein, it is understood that “program code” refers to any collection of instructions, in any language, code or notation, that cause a computing device having an information processing capability to perform a particular action. To this extent, the salt loading model program 140 can be embodied as any combination of system software and/or application software which is executed to generate a salt loading coefficient map which may be integrated along one or more specified roads within a specified catchment area to compute the total estimated salt concentration at a selected drainage point for the specified catchment area. In any event, the technical effect of computer system 102 is to provide processing instructions to computing device 104 in order efficiently compute an estimated salt concentration at a selected drainage point by executing the salt loading model program 140.

Further, the salt loading model program 140 can be implemented using a set of modules 141-144. In this case, each module 141-144 can enable computer system 102 to perform a set of tasks used by the salt loading model program 140, and can be separately developed and/or implemented apart from other portions of the salt loading model program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 includes multiple computing devices 104, each computing device 104 may have at least a portion of the salt loading model program 140 fixed thereon (e.g., one or more modules 141-144). However, it is understood that computer system 102 and the salt loading model program 140 are only representative of various possible equivalent computer systems that may perform a process described herein. To this extent, in other embodiments, the functionality provided by computer system 102 and the salt loading model program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, the salt loading model program 140 provides a first-order model that enables computer system 102 to estimate the spatial differentiation on the environmental impact of road salt in a specified watershed area using only topological information for the specified watershed area. To this end, the salt loading model program 140 may include a salt loading coefficient map module 141. In operation, the salt loading coefficient map module 141 may be embodied with a static hydrological flow model of a “wash bucket” having a water storage component and a flow routing component. In such embodiments, it is assumed that water has an infinite capacity to absorb salt solute, regardless of the current salt concentration, so that the salt is dissolved instantaneously without reaching saturation in the runoff In addition, it is assumed that the only salt transport mechanism is through surface and shallow subsurface runoff which is determined by the elevation difference between a specific target point on the landscape and a flow drainage point for the local catchment area. This second assumption limits the application of the salt loading model program 140 to near-shore flow drainage points, as opposed to long-range salt transport scenarios. The disclosed hydrological flow model is illustrated with the simplified salt flow model 10 which shows a target point in the landscape with a given salt mass 12 which is located downslope from an effective runoff reservoir 11 and which is located upslope from a catchment infusion point in the local catchment area 18, such as the water level of a lake or creek. The load for the salt mass 12 may be determined by the amount of water in the reservoir 11 (which will eventually carry the salt into the local catchment area 18) and the difficulty for the salt to travel to the flow drainage point in the local catchment area 18 (which may be represented by the travel distance for the water flow). The salt loading coefficient map module 141 may effectively determine the amount of water in the reservoir 11 by computing the specific catchment area a which is the ratio between the upslope catchment area scaled by the unit length of the contour line:

a=All,

where A is the up-slope catchment area and l is the length of the contour line at the specified salt mass location. In FIG. 1, the upslope catchment area A is shaded, and the length of the contour line l is shown with the thickened line.

As for determining the measure of difficulty for the salt to travel to the flow drainage point, this may be computed by the salt loading coefficient map module 141 as a function of the straight line slope (e.g., tan β=s/d) between the target point on the landscape and the destination flow drainage point as measured by the straight line 14. To simplify the computation of the difficulty measure, the straight line 14 is used to determine the slope instead of any local slope measure from the actual contour line 16.

With this simplified hydrological flow model, the salt loading coefficient map module 141 can generate a salt loading coefficient map using only topological elevation data by computing salt loading coefficient values c=l/(l+e^{-λ}) for each target point in the landscape catchment area, where the topographical index term λ=ln(α(α₀ tan β)) is computed on the basis of α (equivalent to the amount of water in the upslope contributing area per unit contour length for each point in the catchment area), tan β (the straight line slope between the target point on the landscape and the destination flow drainage point), and α₀ (a tuning parameter which provides small adjustments to conform the model output to observed data).

While the salt loading coefficient map module 141 may use a customized hydrological flow model to generate the salt loading coefficient map in accordance with the present disclosure, selected embodiments of the disclosed salt loading model 140 may use an existing or off-the-shelf computation tool, such as the TOPMODEL hydrological runoff generation model (Beven and Kirkby, 1979) embodied in any desired computational tool (e.g., the System for Automated Geoscientific Analyses (SAGA) GIS software tool), to assist in the computation of the topographical index term λ. Derived from first-principle shallow groundwater transport mechanisms, the TOPMODEL hydrological model is widely used in hydrological studies to provide a semi-distributed and static model which uses distributed topographic information (e.g., elevation data 154) to compute a topographic wetness index (TWI) value for each cell or region, and to determine therefrom the propensity of the cell or region to become saturated. In the salt loading coefficient map module 141, the topographic wetness index may be determined by the TWI module 143 which computes TWI=ln (α/tan β₀), where α is the local upslope area draining through a certain point per unit contour length, and tan β₀ is the local slope in radians. To correct for the local slope tan β₀ term in the TWI computation, the salt loading coefficient map module 141 may include an extension module 144 which computes a correction term, in (tan β₀/a₀ tan β). By adding the correction term to the computed TWI value, the salt loading coefficient map module 141 may efficiently compute the topographical index term λ as an extension of the computed TWI value:

$$λ = ln ( \frac{a}{{a}_{0} tan β} ) = TWI + ln ( \frac{tan {β}_{0}}{{a}_{0} tan β} ) .$$

Once the topographical index terms λ are computed for the cells in the region of interest, the corresponding salt loading coefficients c(x)=1/(1+e^{-λ(x)}) are computed and assembled by the salt loading coefficient map module 141 to generate a two-dimensional salt loading coefficient map 156 which may be stored in memory 118. Having used only topological or elevation data 154 for the watershed area of interest to compute the topographical index term λ, the salt loading model 140 provides a computationally efficient mechanism which is easy to set up and run without requiring detailed data input requirements for soil conditions, underground rock formations, vegetation coverage and growth, etc. In addition, by implementing the widely-used TOPMODEL hydrological model to generate the two-dimensional salt loading coefficient map 156, the salt loading model 140 provides a scientifically sound, first-order estimation of the spatial differentiation on the environmental impact of road salt in a watershed catchment region of interest. Instead of incurring the computational costs required to determine the exact chloride concentration, the salt loading model 140 generates a two-dimensional salt loading coefficient map 156 which provides a relative metric on which portions of the road will have a bigger contribution to the overall chloride runoff,

While there are a number of possible applications of the two-dimensional salt loading coefficient map 156, one example application is to provide a quick estimate of the chloride contribution from different roads or streets in the water shed, thereby enabling timely adjustments to the salt dispersion rates on the identified roads or streets. To this end, the salt loading model 140 may include a salt contribution integration module 142 which is configured to compute a total estimated salt concentration M at a selected drainage point for the local catchment area. To this end, the salt contribution integration module 142 may compute the drainage point of each local catchment area as the integral of the salt loading coefficients c(x) and amount of salt applied per unit area m(x) along a road L within a specified catchment area as represented by the equation M=∫_{L}m(x)·c(x)dx or in discrete form as M=ₖΣc(k)·m(k)Δxₖ.

While FIG. 1 shows one example of an information handling computer system 100, it will be appreciated that an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

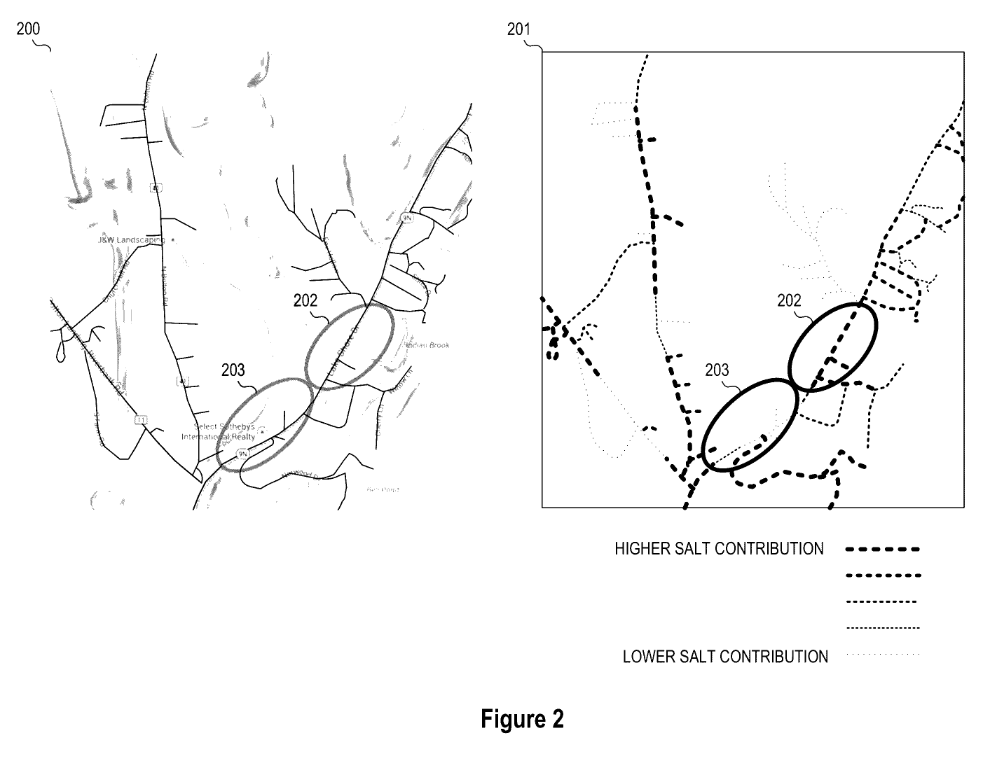

To provide additional details for an improved understanding of selected embodiments of the present disclosure, reference is now made to FIG. 2 which illustrates a two-dimensional salt loading coefficient map 201 generated from topological elevation data 200 representing a geographic region in which roads and streets are constructed. The topological elevation data provides a digital representation of topography and road locations from which the upslope contributing area per unit contour length (α), straight line slope (tan β=s/d), and local line line slope (tan β₀), can be extracted for each cell or region. By loading the topological elevation data as an input, the disclosed salt loading model determines the drainage area for each drainage point using a flow direction algorithm (e.g., the D8 single flow direction algorithm or the D-infinity algorithm) for purposes of computing TWI=ln(α/tan β₀) which is combined with the computed correction term (ln(tan β₀/a₀ tan β)) to compute the topographical index term λ=ln(α/(α₀ tan β))=TWI+ln(tan β₀/a₀ tan β) which is used to generate the salt loading coefficient c(x). Using a two-dimensional map of the roadways in the geographic region, the salt loading coefficients corresponding to road segment locations may be selected to generate the two-dimensional salt loading coefficient map 201 to provide a visual indication of the relative weighting of the salt loading coefficients in each road segment. As shown in FIG. 2, the relative thickness of the dashed lines in the salt loading coefficient map 201 indicates roads with thicker dashed lines provide a higher contribution, while roads with thinner dashed lines provide a lower concentration. For example, the circled region 202, which is located downstream from a large watershed or catchment area, provides a potentially large contribution of road salt, as indicated by the relatively thick salt loading coefficient values. In contrast, the circled region 203, which receives runoff contributions from a small hillside only, provides a smaller contribution of road salt, as indicated by the relatively thin salt loading coefficient values.

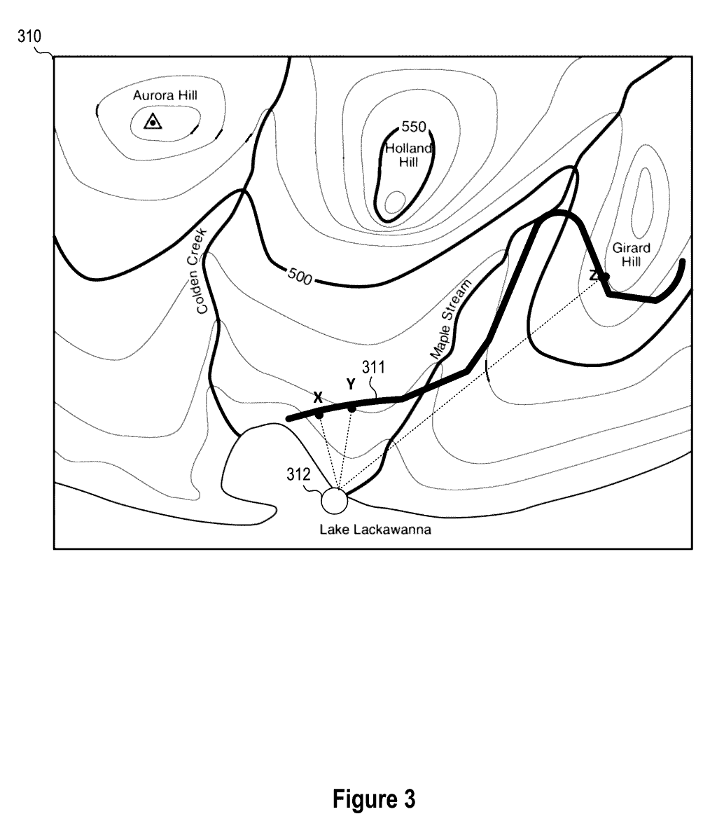

To provide additional details for an improved understanding of selected embodiments of the present disclosure, reference is now made to FIG. 3 which provides an example topographical map illustration 310 of the integration of salt loading coefficients along a road in a drainage basin. In the illustrated topographical map 310, contour lines having a contour interval of 10 feet illustrate the drainage topography for Colden Creek and Maple Stream between three peaks (Aurora Hill, Holland Hill, and Girard Hill) and the Lake Lackawanna. In addition, there is shown a road 311 climbing up from the lake toward Girard Hill. Once the topographical elevation data for the mapped region 310 is processed to compute the e salt loading coefficient values c(x) for all points X, Y, Z, etc.)) along the road 311, the salt dispersion rate or loading applied per unit length m(x) may be derived from a two-dimensional map of the road 311 and/or other data sources, and the resulting product c(x)·m(x) may be integrated along the road segments in the catchment area. 310 to compute the total salt estimation at the shoreline drainage point 312. For example, assuming the equivalent salt applied per unit length is m(x), the salt contribution integration module 142 may be configured to compute the total salt contribution from the road length 311 to the shoreline drainage point 312 as M=∫_{L}m(x)·c(x)dx

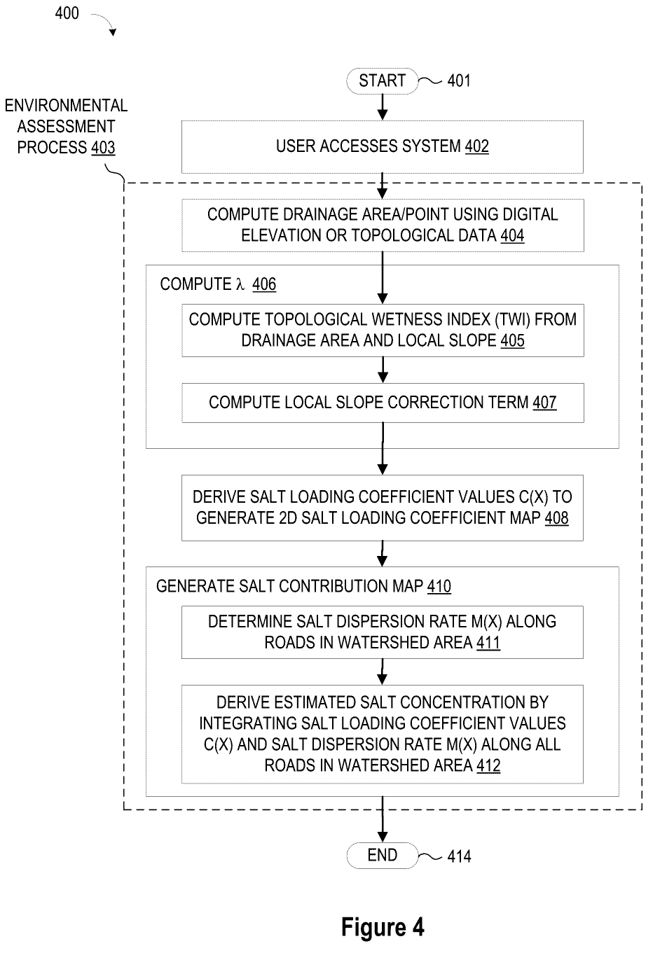

To provide additional details for an improved understanding of selected embodiments of the present disclosure, reference is now made to FIG. 4 which depicts a simplified flow chart 400 showing the logic for efficiently computing a salt loading coefficient map for different road segments and estimating the combined salt concentration at a specified drainage point. The processing shown in FIG. 4 may be performed in whole or in part by an information handling system which runs a salt loading model 142 which estimates the spatial differentiation on the environmental impact of road salt in a specified watershed area using only topological information for the specified watershed area by executing a first-order salt load model to quickly and efficiently compute a relative salt load metric along specified portions of a road to identify which portions of the road will have a bigger contribution to the overall chloride runoff

FIG. 4 processing commences at 401 whereupon, at step 402, a user accesses a system, such as by registering, logging in, or otherwise sending an access or search request to a system. Step 402 may be performed at the information handling system 100 or other computer system as an initial processing step wherein the user access is captured, processed, and stored. The specific access procedures and mechanisms may vary from one system to the next, though the system access may enable detection of the usage scenario associated with the user.

To provide an environmental assessment process 403 which computes a relative metric of the amount of road salt concentration using only topographical elevation data, the information handling system 100 or other computer system loads, accesses, or otherwise retrieves for input digital elevation or topological data which is then used to compute a drainage area and destination drainage point at step 404 in selected embodiments, the up-slope catchment contribution or drainage area may be computed at step 404 using the salt loading coefficient map module 141 which may be configured to use the D8 algorithm (J. F. O'Callaghan et al., “The extraction of drainage networks from digital elevation data,” Computer Vision, Graphics, and Image Processing, vol. 28, no, 3, pp. 323-344 (1984)), the or D-infinity algorithm (D. G. Tarboton, “A new method for the determination of flow directions and upslope areas in grid digital elevation models,” Water Resources Research, vol. 33, no. 2, pp. 309-319 (1997)),or any other suitable area calculation algorithm.

Once the up-slope catchment contribution area and identified drainage point are determined, the topographical index term 2 may be computed at step 406 to determine the salt load contribution of a particular point in the landscape. Generally speaking, the topographical index term λ may be computed at step 406 using the salt loading coefficient map module 141 which may be configured to compute

$$λ = ln ( \frac{a}{{a}_{0} tan β} ) ,$$

where a₀ is the coefficient for tuning.

In accordance with selected embodiments, the computation step 406 may be implemented with two sub-steps 405, 407. In the first sub-step 405 the topological wetness index (TWI) (a.k.a., topological index (TI)) is computed using any suitable TOPMODEL hydrology model tool. For example, the TWI value may be calculated at step 405 using the TWI module 143 which may be configured to compute

$$TWI = ln ( \frac{a}{tan {β}_{0}} ) ,$$

where α is the up-slope catchment contribution or drainage area, and where β₀ is the local slope at the particular point. In the second sub-step 407, a local slope correction term is computed. For example, the correction term may be calculated at step 407 using the extension module 144 which may be configured to compute the value,

$$ln ( \frac{tan {β}_{0}}{{a}_{0} tan β} ) .$$

By additively combining the TWI and slope correction terms, the computation step 406 computes the topographical index term

$$λ = ln ( \frac{a}{{a}_{0} tan β} ) = TWI + ln ( \frac{tan {β}_{0}}{{a}_{0} tan β} ) .$$

Using the topographical index term λ computed from the TWI and local slope correction terms at step 406, the salt loading coefficient values c(x) may be derived at step 408 to generate a two-dimensional salt loading coefficient map for all drainage points in the selected watershed area. The processing at step 408 may be performed using the salt loading coefficient map module 141, though any desired information processing system for generating the salt loading coefficient maps may be used. As described herein, a two-dimensional map of any roads in the selected watershed area may be used to select the salt loading coefficients for each road segment, thereby generating the salt loading coefficient map.

Using the salt loading coefficient map generated at step 408, the salt contribution map may be generated at step 410 to estimate the road salt contribution from roads in different parts of the selected watershed area. Generally speaking, the salt contribution map may be generated at step 410 using the salt contribution integration module 142, though any desired information processing system for generating the salt contribution map may be used.

In accordance with selected embodiments, the computation step 410 may be implemented with two sub-steps 411, 412. In the first sub-step 411, the salt dispersion rate m(x) is determined along all roads in the selected watershed area. For example, a salt dispersion rate dataset m(x) may be input along with the salt loading coefficient map, where the salt dispersion rate dataset m(x) specifies the amount of salt applied per unit length for each road segment or point in the watershed area. In the second sub-step 412, the total estimated salt contribution from the road segments to the specified near-shore drainage point is derived by integrating the salt loading coefficient values c(x) and salt dispersion rate m(x) along all road segments in the watershed. For example, the integral computation may be calculated at step 412 using the salt contribution integration module 142 which may be configured to compute the integral value, M=∫_{L}(x)·c(x)dx.

By now, it will be appreciated that there is disclosed herein a system, method, apparatus, and computer program product for assessing environmental effect of road salt distribution in a watershed area with an information handling system having a processor and a memory. As disclosed, the system, method, apparatus, and computer program product receive a topographical model for the watershed area, such as by retrieving digital elevation data from system memory. Using a specified catchment area and local hydraulic gradient extracted from the topographical model, a salt loading coefficient metric is computed for each of a plurality of target points in the watershed area in addition, each salt loading coefficient metric is mapped to a corresponding road segment in the watershed area to generate a salt loading coefficient map to provide a first-order model estimation of spatial differentiation on the environmental effect of road salt distribution in the watershed area. In selected embodiments, the computation of the salt loading coefficient metric includes computing a topographical index term λ=ln(α/(α₀ tan β)), where α specifies an amount of wafer in an upslope contributing area per unit contour length for each target point in the watershed area, where tan β specifies a straight line topographic slope between the target point and a destination flow drainage point, and where α₀ specifies a tuning coefficient. In other embodiments, the computation of the salt loading coefficient metric includes computing a topological wetness index TWI term, ln(α/tan β₀), for each target point in the watershed area, where α specifies an amount of water in an upslope contributing area per unit contour length for each target point in the watershed area, and where tan β specifies a local surface topographic slope at the target point; computing a local slope correction term, ln(tan β₀/(α₀ tan β), where tan β specifies a straight line topographic slope between the target point and a destination flow drainage point, and where α₀ specifies a tuning coefficient; and adding the topological wetness index TWI term and local slope correction term to compute a sum term λ. In either case, the salt loading coefficient metric is determined by computing, for each target point in the watershed area, a salt loading coefficient metric value c=1/(1+e^{-λ}). The disclosed system, method, apparatus, and computer program product may also compute a total salt contribution to a selected drainage point from each road located in the watershed area by integrating a total salt contribution value M=∫_{L}m(x)·c(x)dx, where L specifies road segments for each road located in the watershed area, m(x) specifies a salt dispersion rate along each road L, and c(x) specifies the salt loading coefficient metric corresponding to each road segment in the watershed area contained in the salt loading coefficient map.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will he explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method, in an information handling system comprising a processor and a memory, for assessing environmental effect of road salt distribution in a watershed area, the method comprising:
receiving, by the system, a topographical model for the watershed area;
computing, by the system, a salt loading coefficient metric for each of a plurality of target points in the watershed area using a specified catchment area and local hydraulic gradient extracted from the topographical model; and
mapping, by the system, each salt loading coefficient metric to a corresponding road segment in the watershed area to generate a salt loading coefficient map to provide a first-order model estimation of spatial differentiation on the environmental effect of road salt distribution in the watershed area.

2. The method of claim 1, wherein receiving the topographical model comprises retrieving digital elevation data from system memory.

3. The method of claim 1, wherein computing the salt loading coefficient metric comprises computing a topographical index term λ=ln(α/(α₀ tan β), where α specifies an amount of water in an upslope contributing area per unit contour length for each target point in the watershed area, where tan β specifies a straight line topographic slope between the target point and a destination flow drainage point, and where α₀ specifies a tuning coefficient.

4. The method of claim 3, wherein computing the salt loading coefficient metric comprises computing, for each target point in the watershed area, a salt loading coefficient metric value c=1/(1+e^{-λ})

5. The method of claim 1, wherein computing the salt loading coefficient metric comprises:
computing a topological wetness index TWI term, ln(α/tan β₀), for each target point in the watershed area, where α specifies an amount of water in an upslope contributing area per unit contour length for each target point in the watershed area, and where tan β₀ specifies a local surface topographic slope at the target point;
computing a local slope correction term, ln(tan β₀/(α₀ tan β)), where tan β specifies a straight line topographic slope between the target point and a destination flow drainage point, and where α₀ specifies a tuning coefficient; and
adding the topological wetness index TWI term and local slope correction term to compute a sum term λ.

6. The method of claim 5, wherein computing the salt loading coefficient metric comprises computing, for each target point in the watershed area, a salt loading coefficient metric value c=1/(1+e^{-λ}).

7. The method of claim 1, further comprising computing a total salt contribution to a selected drainage point from each road located in the watershed area by integrating a total salt contribution value M=∫_{L}m(x)·c(x)dx, where L specifies road segments for each road located in the watershed area, m(x) specifies a salt dispersion rate along each road L, and c(x) specifies the salt loading coefficient metric corresponding to each road segment in the watershed area contained in the salt loading coefficient map.

8. An information handling system comprising:
one or more processors;
a memory coupled to at least one of the processors;
a set of instructions stored in the memory and executed by at least one of the processors to assess environmental effect of road salt distribution in a watershed area, wherein the set of instructions are executable to perform actions of:
receiving, by the system, a topographical model for the watershed area;
computing, by the system, a salt loading coefficient metric for each of a plurality of target points in the watershed area using a specified catchment area and local hydraulic gradient extracted from the topographical model; and
mapping, by the system, each salt loading coefficient metric to a corresponding road segment in the watershed area to generate a salt loading coefficient map to provide a first-order model estimation of spatial differentiation on the environmental effect of road salt distribution in the watershed area.

9. The information handling system of claim 8, wherein the set of instructions are executable to receive the topographical model by retrieving digital elevation data from system memory,

10. The information handling system of claim 8, wherein the set of instructions are executable to compute the salt loading coefficient metric by computing a topographical index term λ=ln(α/α₀ tan β)), where α specifies an amount of water in an upslope contributing area per unit contour length for each target point in the watershed area, where tan β specifies a straight line topographic slope between the target point and a destination flow drainage point, and where α₀ specifies a tuning coefficient.

11. The information handling system of claim 10, wherein the set of instructions are executable to compute the salt loading coefficient metric by computing, for each target point in the watershed area, a salt loading coefficient metric value c=1/(1+e^{-λ}).

12. The information handling system of claim 8, wherein the set of instructions are executable to compute the salt loading coefficient metric by:
computing a topological wetness index TWI term, ln(α/tan β₀), for each target point in the watershed area, where α specifies an amount of water in an upslope contributing area per unit contour length for each target point in the watershed area, and where tan β₀ specifies a local surface topographic slope at the target point;
computing a local slope correction term, ln(tan β₀/(α₀ tan β)), where tan β specifies a straight line topographic slope between the target point and a destination flow drainage point, and where α₀ specifies a tuning coefficient; and
adding the topological wetness index TWI, term and local slope correction term to compute a sum term λ.

13. The information handling system of claim 12, wherein the set of instructions are executable to compute the salt loading coefficient metric by computing, for each target point in the watershed area, a salt loading coefficient metric value c=1/(1+e^{-λ}).

14. The information handling system of claim 8, further comprising instructions that are executable to compute a total salt contribution to a selected drainage point from each road located in the watershed area by integrating a total salt contribution value M=∫_{L}m(x)·c(x)dx, where L specifies road segments for each road located in the watershed area, m(x) specifies a salt dispersion rate along each road L, and c(x) specifies the salt loading coefficient metric corresponding to each road segment in the watershed area contained in the salt loading coefficient map.

15. A computer program product stored in a computer readable storage medium, comprising computer instructions that, when executed by an information handling system, causes the system to assessing environmental effect of road salt distribution in a watershed area by performing actions comprising:
receiving, by the system, a topographical model for the watershed area;
computing, by the system, a salt loading coefficient metric for each of a plurality of target points in the watershed area using a specified catchment area and local hydraulic gradient extracted from the topographical model; and
mapping, by the system, each salt loading coefficient metric to a corresponding road segment in the watershed area to generate a salt loading coefficient map to provide a first-order model estimation of spatial differentiation on the environmental effect of road salt distribution in the watershed area.

16. The computer program product of claim 15, wherein computing the salt loading coefficient metric comprises computing a topographical index term λ=ln(α/(α₀ tan β)), where α specifies an amount of water in an upslope contributing area per unit contour length for each target point in the watershed area, where tan β specifies a straight line topographic slope between the target point and a destination flow drainage point, and where α₀ specifies a tuning coefficient.

17. The computer program product of claim 16, wherein computing the salt loading coefficient metric comprises computing, for each target point in the watershed area, a salt loading coefficient metric value c=1/(1+e^{-λ}).

18. The computer program product of claim 15, wherein computing the salt loading coefficient metric comprises:
computing a topological wetness index TWI term, ln(α/tan β₀), for each target point in the watershed area, where α specifies an amount of water in an upslope contributing area per unit contour length for each target point in the watershed area, and where tan β₀ specifies a local surface topographic slope at the target point;
computing a local slope correction term, ln(tan β₀/(α₀ tan β)), where tan β specifies a straight line topographic slope between the target point and a destination flow drainage point, and where α₀ specifies a tuning coefficient; and
adding the topological wetness index TWI term and local slope correction term to compute a sum term λ.

19. The computer program product of claim 18, wherein computing the salt loading coefficient metric comprises computing, for each target point in the watershed area, a salt loading coefficient metric value c=1/(1+e^{-λ}).

20. The computer program product of claim 15, further comprising instructions that, when executed by an information handling system, causes the system compute a total salt contribution to a selected drainage point from each road located in the watershed area by integrating a total salt contribution value M=∫_{L}m(x)·c(x)dx, where L specifies road segments for each road located in the watershed area, m(x) specifies a salt dispersion rate along each road L, and c(x) specifies the salt loading coefficient metric corresponding to each road segment in the watershed area contained in the salt loading coefficient map.
